(19) United States
(12) Patent Application Publication
(10) Pub. No.: US 2019/0003715 A1
(43) Pub. Date: Jan. 3, 2019

(54) ELECTROMAGNETIC WAVE HEATING SYSTEM

(71) Applicant: IMAGINEERING Inc., Kobe-shi, Hyogo (JP)

(72) Inventors: Yuji Ikeda, Kobe-shi (JP); Minoru Makita, Kobe-shi (JP)

(73) Assignee: IMAGINEERING Inc., Kobe-shi, Hyogo (JP)

(21) Appl. No.: 15/748,961

(22) PCT Filed: Aug. 1, 2016
(86) PCT No.: PCT/JP2016/072514

§ 371 Date: Jan. 30, 2018

(30) Foreign Application Priority Data
Jul. 31, 2015 (JP) 2015-151579

(51) Int. Cl. F24C 7/02; H05B 6/68; H05B 6/72; H05B 6/70

(52) U.S. Cl. CPC F24C 7/02; H05B 6/686; H05B 2206/04; H05B 6/70; H05B 6/72

(57) ABSTRACT

To reduce a limitation in a heat method caused by an interference of an electromagnetic wave in an electromagnetic wave beating system that uses an electromagnetic wave generator by a semiconductor element. The electromagnetic wave heating system comprises a heat chamber having a first wall surface and a second wall surface different from the first wall surface, in which an object is placed to be heated, a first flat antenna arranged on the first wall surface of the heat chamber and configured to emit an electromagnetic wave so as to heat the object inside the heat chamber, a second flat antenna arranged on the second wall surface and configured to emit an electromagnetic wave so as to heat the object inside the heat chamber, an electromagnetic wave generator comprising a semiconductor element and configured to output the electromagnetic wave, a switcher configured to supply the electromagnetic wave outputted from the electromagnetic wave generator to any one of the first flat antenna or the second flat antenna so as to switch the first and second flat antennas to emit the electromagnetic wave, and a controller configured to control the electromagnetic wave generator and the switcher.

### TECHNICAL FIELD

The present invention relates to an electromagnetic wave heating system such as a microwave oven, specifically an electromagnetic wave heating system that heats food by using a plurality of array antennas for emitting an electromagnetic wave such as microwave and uses a high frequency switcher configured to switch the array antenna to be supplied of the electromagnetic wave in high speed.

### BACKGROUND ART

The microwave oven that uses the microwave generation device by the semiconductor element instead of magnetron has been considered in these days. For example, referring to Patent Document 1, the microwave heater is disclosed, which provides with the irradiation antennas for irradiating the microwave to top, bottom, left, and right wall surfaces of the heating room. The microwave heater includes two oscillators, microwave outputted from the first oscillator is distributed in two ways at the first distributer, supplied into the antenna on the top plate and on the bottom plate, and microwave outputted from the second oscillator is distributed in two ways at the second distributer and supplied into the antenna on the left plate and on the right plate.

### PRIOR ART DOCUMENTS

### Patent Document(s)

Patent Document 1: WO2010/032345

### SUMMARY OF INVENTION

### Problem to be Solved by Invention

According to the microwave heater in Patent Document 1, there may be a case where the reflected wave from the top-surface-antenna regurgitates to the distributer, the regurgitated reflected wave propagates to the bottom-surface-antenna, and resulting in interference. Accordingly, pattern of microwave emitted from the top-surface-antenna and the bottom-surface-antenna is limited to the one having a condition of not-occurring an interference. Originally, the microwave heater provided with the semiconductor element has an advantage of being able to cook with heat efficiently by changing freely the microwave length, phase, or timing; however, by the above limitation, the advantage by the semiconductor element cannot be utilized well with the microwave heater disclosed in Patent Document 1.

The present invention is made from the above viewpoints.

### Means for Solving the Above Problems

An electromagnetic wave heating system of the present invention comprises a heat chamber having a first wall surface and a second wall surface different from the first wall surface, in which an object is placed to be heated, a first flat antenna arranged on the first wall surface of the heat chamber and configured to emit an electromagnetic wave so as to heat the object inside the heat chamber, a second flat antenna arranged on the second wall surface and configured to emit an electromagnetic wave so as to heat the object inside the heat chamber, an electromagnetic wave generator comprising a semiconductor element and configured to output the electromagnetic wave, a switcher configured to supply the electromagnetic wave outfitted from the electromagnetic wave generator to any one of the first flat antenna or the second flat antenna so as to switch the first and second flat antennas to emit the electromagnetic wave, and a controller configured to control the electromagnetic wave generator and the switcher.

### Effect of Invention

According to the present invention, in an electromagnetic wave heating system that manages a plurality of flat antennas supplied of an electromagnetic wave from an electromagnetic wave generator by use of a semiconductor element on the top, bottom, left, and right wall surfaces, and etc. of a heat chamber, a limitation caused of an interference of an electromagnetic wave regarding an object heating method can be reduced, and an advantage of the electromagnetic wave generator by the semiconductor element can be utilized well, compared to a case where the electromagnetic wave is supplied into the plurality of flat antennas simply by using the distributer, since it is configured to switch flat antennas supplied of an electromagnetic wave by using a switcher.

### BRIEF DESCRIPTION OF FIGURES

FIG. 1 shows a schematic structural view of a microwave oven of the present embodiment.

FIG. 2 shows the schematic structural view of a flat antenna of the microwave oven of the present embodiment.

FIG. 3 is a perspective view of the flat antenna of the present embodiment.

FIG. 4 is a front view of the flat antenna of the present embodiment, (a) shows a structure of a substrate on the front surface side, and (b) shows the structure of a substrate on the back surface side.

FIG. 5 is the schematic structural view of a switcher of the present embodiment.

FIG. 6 shows a timing chart of control for the microwave oven of the present embodiment.

### EMBODIMENTS FOR IMPLEMENTING THE INVENTION

In below, embodiments of the present invention are described in details based on figures. Note that following embodiments are essentially preferable examples, and the scope of the present invention, the application, or the use is not intended to be limited.

### First Embodiment

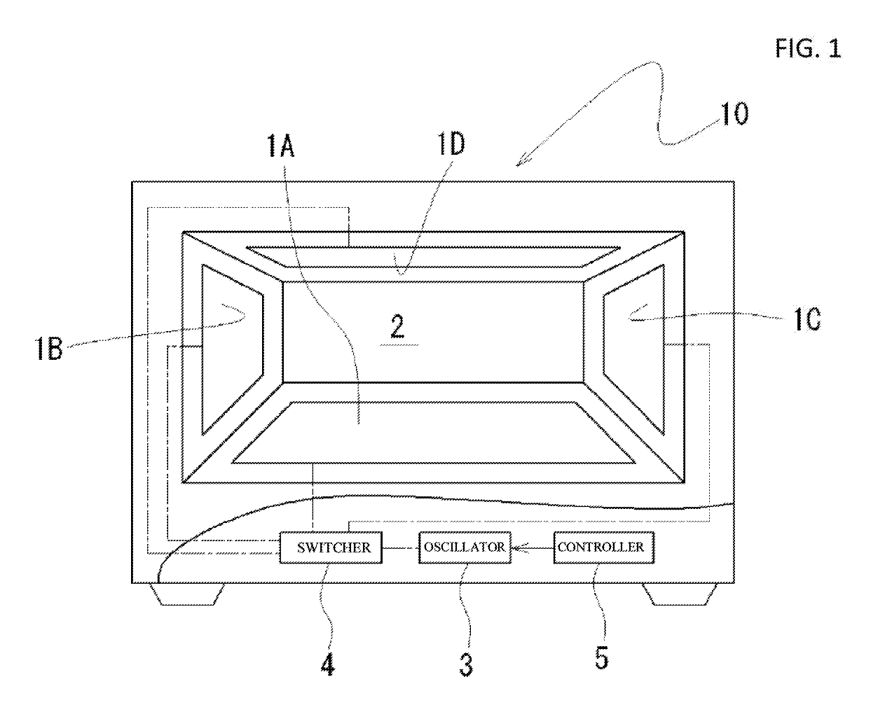

Referring to FIG. 1, a microwave oven 10, one example of an electromagnetic wave heating system of the present invention, comprises a heat chamber 2 configured to place an object therein, flat antennas from 1A through 1D arranged on top, bottom, left, and right wall surfaces of the heat chamber, an oscillator 3 configured to generate a microwave, a switcher 4 configured to switch a supply destination of microwave inputted from the oscillator 3, a controller 5 configured to control the oscillator 3 and the switcher 4, and a coaxial line 6 connected the switcher 4 with respective flat antennas 1.

Each flat antenna 1A to 1D is arranged on a wall surface made of metal through an insulator such as ceramics with heat resistance characteristic. Moreover, a mount table on which an object is placed, is also formed by an insulator such as ceramics with heat resistance characteristic, and arranged on the flat antenna 1A provided at the bottom wall surface side.

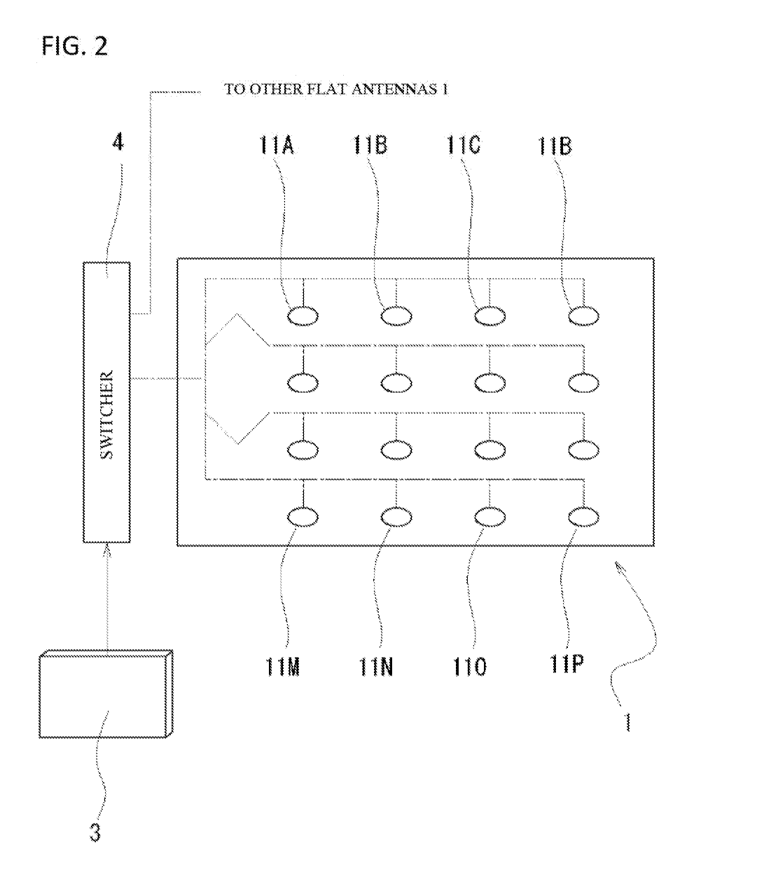

Referring to FIG. 2, each flat antenna 1, total sixteen small sized sub antennas 11A to 11P are arranged by four column×four row in an array manner. Each small sized sub antenna 11 is arranged so as to have an equal distance from the switcher 4.

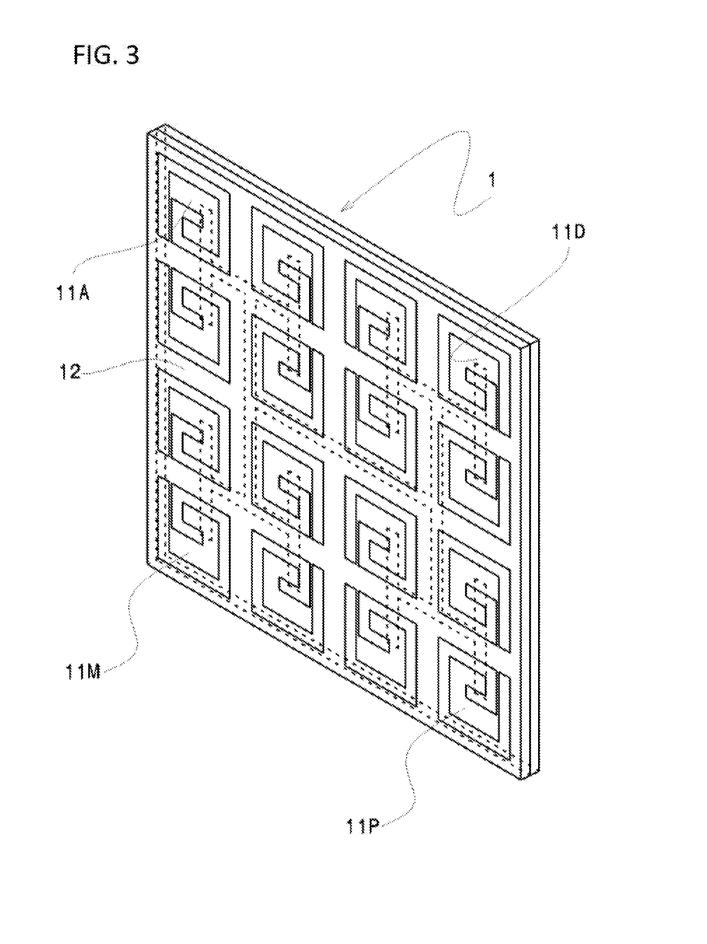

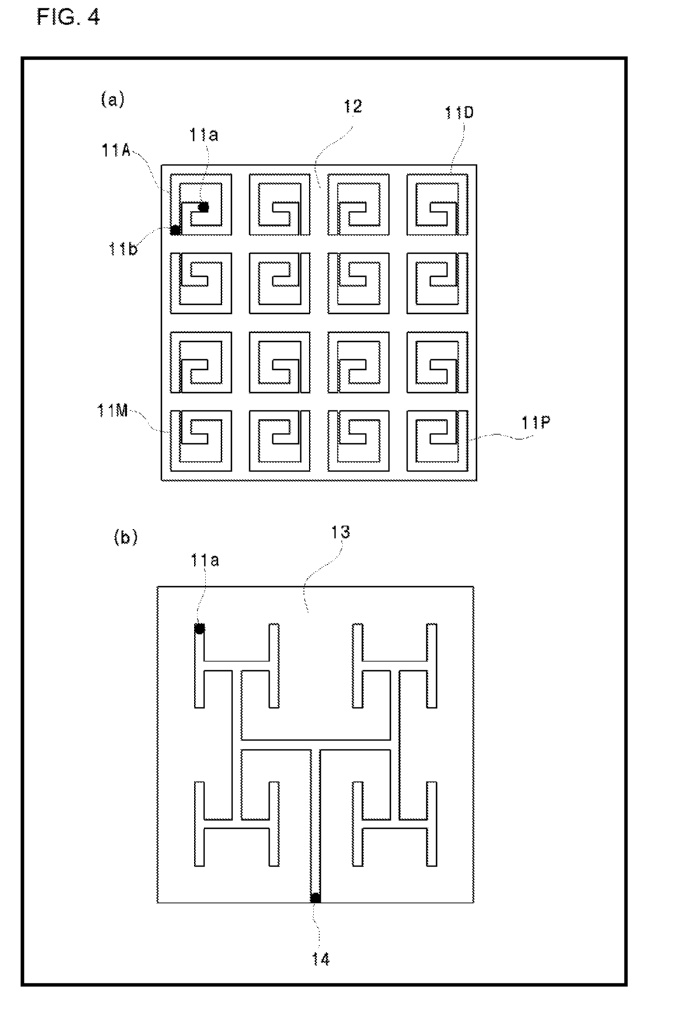

Referring to FIGS. 3 and 4, the flat antenna 1 comprises a first substrate 12 on front surface and a second substrate 13 on back surface.

The first substrate 12 is constituted by a substrate such as ceramics and etc. with an insulation characteristics, and sixteen metal patterns in a spiral manner are formed on the surface thereof. Each metal pattern corresponds to one of small sized sub antennas 11.

The second substrate 13 on the back surface includes a power feed point 14 formed at the base configured to receive a microwave from the switcher 14. Further, a metal pattern for delivering microwave from the power feed point 14 to respective small sub antennas 11 is formed on the surface.

Each small sized sub antenna 11 is formed spirally at the center of a power receiving end 11a inputted of the microwave, and formed such that a length between the power receiving end 11a and an opening end 11b becomes approximately ¼ wavelength of microwave. Moreover, a through hole is formed at a position of the power receiving end 11a of each small sized sub antenna 11 of the first substrate 12. A via is filled with at the through hole, and the metal pattern of the first substrate 12 is connected to the metal pattern of the second substrate 13 through the via.

An arrangement is made such that the distance from the power feed point 14 to each power receiving end 11a of the corresponding antenna 11 in number of sixteen, may be equal. Accordingly, the sixteen antennas simultaneously become ON or OFF based on an output pattern from the oscillator 3 in principle since microwave in same phase is supplied into the sixteen antennas.

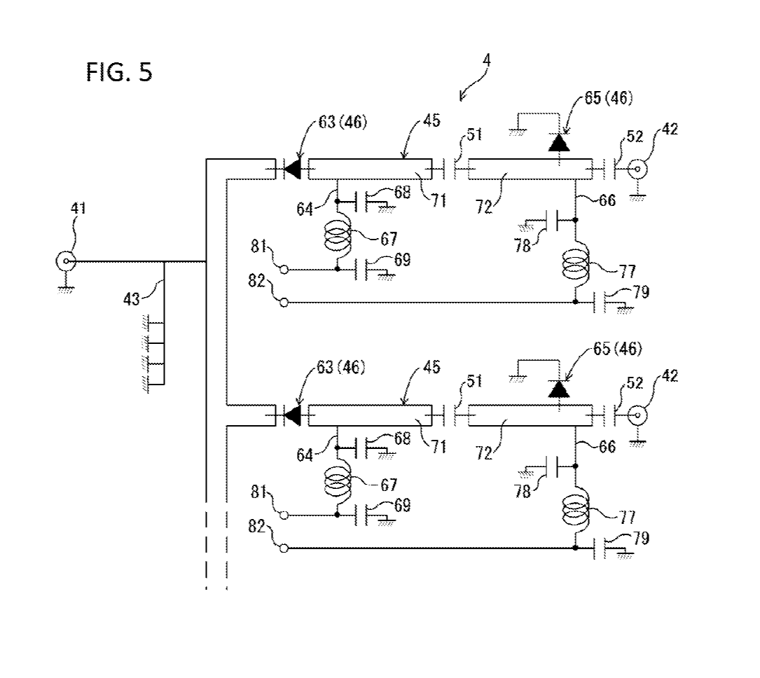

Referring to FIG. 5, the switcher 4 comprises an input terminal 41 (an input part), a plurality of output terminals 42 (output parts), and a plurality of branch transmission lines 45 (transmission parte). The microwave outputted from the oscillator 3 is inputted into the input terminal 41. The microwave outputted from the respective output terminals 42 is connected to the power feed point 14 of each flat antenna 1. The branch transmission line 45 is provided in correspondence to one output terminal 42. The input terminal 41 is grounded via a ground line 43 at the input side.

Each branch transmission line 45 comprises a switching means 46 for switching an ON state that allows for microwave passage and an OFF state that does not allow for microwave passage. Each switching means 46 includes a transmission-side diode 63 and a ground-side diode 65 that are constituted of PIN diode and etc. Each branch transmission hue 45 is provided with a capacitor 51 and a capacitor 52 in this order seem from the input terminal 41 side.

In the transmission side diode 63, a “cathode” is connected to the input terminal 41 side, and an “anode” is connected to a first strip line 71. A bias-line 64 is provided with at the “anode” side of the transmission-side diode 63 (the first strip line 71), and the other end of the bias-line 64 is connected to a signal input part 81. The capacitor 51 is connected at the output terminal 42 side of the first strip line 71. A second strip line 72 is connected at the output terminal 42 side of the capacitor 51.

The “cathode” is grounded at the ground-side diode 65, and the “anode” is connected to the second strip line 72. A bias-line 66 is provided at the “anode” side (second strip line 72) of the ground-side diode 65, and the other end of the bias-line 66 is connected to a signal input part 82.

An inductor 67 is provided at the bias-line 64 at the transmission side, and both ends of the inductor 67 are grounded through capacitors 68 and 69. An inductor 77 is provided at the bias-line 66 at the ground side, and both ends of the inductor 77 are grounded through capacitors 78 and 79.

The input side ground line 43 is branched into a plurality of branch ground lines. An electrical length up to the oscillator 3 can be adjusted by selecting the branch ground line 43 to be eliminated off. Accordingly, an adjustment with respect to a circuit impedance variation caused by an assembly tolerance variation and a component variability on manufacturing can be performed also at final stage of manufacturing.

With respect to the branch transmission line 45a in correspondence to the output terminal 42 for outputting the microwave, a positive bias voltage is applied to the signal input part 81 of the bias-line 64 at the transmission side, while, a negative bias voltage is outputted to the signal input part 82 of the bias-line 66 at the ground side. Thereby, the transmission-side diode 63 to which forward-bias is applied, is conducted through at the output side transmission line 45a, and the ground-side diode 65 to which reverse-bias is applied, is blocked.

With respect to the branch transmission line 45b in correspondence to the output terminal 42 not to output the microwave, the negative bias voltage is applied to the signal input part 81 of the bias line 64 at the transmission side, while, the positive bias voltage is outputted to the signal input part 82 of the bias line 66 at the ground side. Thereby, the transmission-side diode 63 to which reverse-bias is applied, is blocked, and the ground-side diode 65 to which forward-bias is applied, is conducted through at non-output side transmission line 45b.

From these above results, since the output side transmission line 45a is conducted through, and the non-output side transmission lines 45b become blocked seen from the input terminal 41, the microwave inputted into the input terminal 41 is outputted from the output terminal 42 via the output side transmission line 45a.

Thus, with the above switcher 4, the amount of microwave outputted from the output terminal 42 of the non-output side transmission line 45b is reduced since the ground-side diode 65 is conducted through at the non-output side transmission line 45b, and the impedance at the output terminal 42 side is increased based on a stray capacitance at the non-output side transmission line 45b. Accordingly, even if a diode is used in order to perform to switch in high speed the output terminal 42 for outputting the microwave, much high frequency energy can be delivered to the output terminal 45 of the output side transmission line 45a.

Moreover, with the switcher 4, it is constituted such that a distance from the transmission-side diode 63 to the ground point becomes optimized, and then the non-output side transmission line 45b does not affect to the output side transmission line 45a. An impedance seen from the input terminal 41 becomes only the impedance of the output side transmission line 45a. It is easy to attain an impedance matching. Accordingly, further much microwave energy can be supplied into the output terminal 42 for outputting the microwave, and switching of the output terminal 42 for outputting the microwave can be performed in further lower loss.

Moreover, with the switcher 4, an energization power distribution area size of the transmission-side bias line 64 and the ground-side bias line 66 becomes smaller compared to the branch transmission line 45, and the microwave impedance of respective bias-lines 64, 66 seen from the input terminal 41 is kept in high. Accordingly, an influence of respective bias-lines 64 and 66 on microwave transmission at the branch transmission line 45 is reduced, and a switching of the output terminal 42 for outputting the microwave can be performed at further lower loss.

Moreover, with the switcher 4, a plurality of branch ground lines having different electrical lengths are provided at the input side ground line, and the electrical length of the input side ground line becomes adjusted after completion of the switcher 4. Therefore, with respect to the circuit impedance variation caused by an assembly tolerance variation of the switcher 4 and the component variability, an impedance adjustment can be attained toward each switcher 4. Accordingly, an impedance matching can be maintained in a best state under the use of the switcher 4 connecting to both the oscillator 3 and the flat antenna 1.

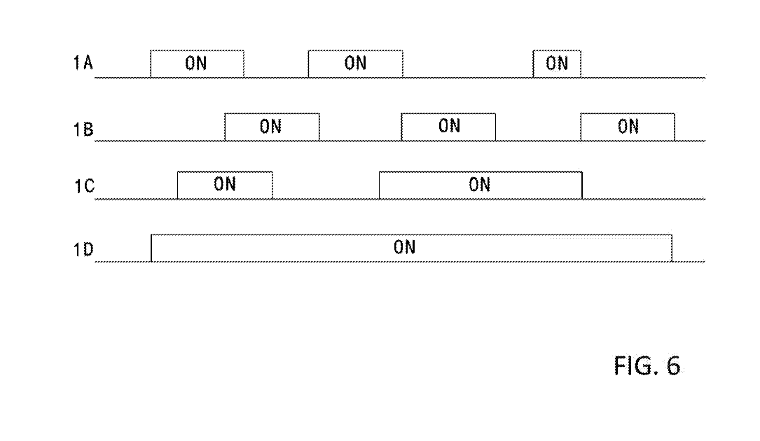

FIG. 6 shows a time-chart that illustrates a pattern of microwave emitted from the flat antennas 1A to 1D. According to the microwave oven 10 of the present embodiment, the microwave emission pattern from each flat antenna 1 can be set freely. On the other hand, since it is constituted that the microwave is simply branched from one oscillator to two antennas in the microwave oven disclosed in Patent Document 1, the bottom surface antenna 1A and the top surface antenna 1D for example cannot emit the microwave only in the same timing. The original merit of the microwave generation device by the semiconductor element exists in a point where the microwave oscillation pattern (timing or amplitude) can be controlled freely; however, microwave oscillation pattern is limited from the above reasons in the invention of Patent Document 1, and the merit of the microwave generation device by the semiconductor element cannot be utilized well. On the other hand, according to the microwave oven 10 of the above embodiment, a driven antenna can individually be selected since the switcher 4 configured to be able to switch the microwave in high speed is used.

Furthermore, with the above microwave oven 10, each flat antenna 1 is formed by array antennas in number of sixteen small sized sub antennas 11. Accordingly, even if an error in antenna operation frequency occurs caused by component tolerance or variations and etc., the error is averaged since the number of antennas is large, and as the result, the microwave can stably be supplied into an object inside the heat chamber.

### INDUSTRIAL APPLICABILITY

As illustrated as above, the present invention is effective to an electromagnetic wave heating system such as a microwave oven.

### NUMERAL SYMBOLS EXPLANATION

1. Flat Antenna
2. Heat Chamber
3. Oscillator
4. Switcher
5. Controller
6. Coaxial Line
11. Small-sized Sub Antenna
12. First Substrate
13. Second Substrate
14. Power Feed Point

1. An electromagnetic wave heating system comprising:
a heat chamber having a first wall surface and a second wall surface different from the first wall surface, in which an object is placed to be heated;
a first flat antenna arranged on the first wall surface of the heat chamber and configured to emit an electromagnetic wave so as to heat the object inside the heat chamber;
a second flat antenna arranged on the second wall surface and configured to emit an electromagnetic wave so as to heat the object inside the heat chamber;
an electromagnetic wave generator comprising a semiconductor element and configured to output the electromagnetic wave;
a switcher configured to supply the electromagnetic wave outputted from the electromagnetic wave generator to any one of the first flat antenna or the second flat antenna so as to switch the first and second flat antennas to emit the electromagnetic wave; and
a controller configured to control the electromagnetic wave generator and the switcher.

2. The electromagnetic wave heating system according to claim 1,
wherein the switcher comprises an input pan configured to receive the electromagnetic wave that is outputted from the electromagnetic wave generator, a plurality of output parts configured to output the electromagnetic wave inputted from the input part, and a plurality of transmission parts each provided to one of the output pans and configured to transmit the electromagnetic wave from the input part to the corresponding output part, and
wherein the input part comprises an input terminal and a ground line having a plurality of branch lines each grounded for grounding the input terminal, the branch lines having different electrical lengths from one another.

3. The electromagnetic wave heating system according to claim 1,
wherein each of the first fiat antenna and the second flat antenna comprises a power feed point configured to receive power from the corresponding output part of the switcher, and a plurality of sub antennas arranged in an array manner, and
wherein each of the plurality of sub antennas has a power receiving end to receive the power from the output part and is formed in a spiral shape that has the power receiving end at a center and spirally extends therefrom to an opening end thereof such that a length between the power receiving end and the opening end becomes ¼ wavelength of the electromagnetic wave, and the plurality of sub antennas are arranged such that a distance between each power receiving end of the plurality of antennas and the power feed point becomes equal to one another.
